(19) United States
(12) Patent Application Publication
(10) Pub. No.: US 2003/0014304 A1
(43) Pub. Date: Jan. 16, 2003

(54) Method of analyzing internet advertising effects

(75) Inventors: Sarah Calvert, Seattle, WA (US); Chen Yu, Seattle, WA (US)

Correspondence Address: BENNET K. LANGLOTZ, P. C., BOX 759, GENOA,, NV, 89411, US

(73) Assignee: Avenue A, Inc.

(21) Appl. No.: 09/902,833

(22) Filed: Jul. 10, 2001

(51) Int. Cl. G06F 17/60

(52) U.S. Cl. 705/14

(57) ABSTRACT

A method of evaluating Internet advertisement effectiveness that involves collecting Internet activity information associated with a multitude of cookies, and storing the information in a database. An advertisement strategy is generated for evaluation, and a plurality of user segments are established, each having a different Internet activity characteristic. An advertising strategy is assigned to each segment. When a user visits a site where an advertisement is to be served, a cookie is determined. The stored Internet activity information for the cookie is retrieved, and based on the retrieved information, the cookie is assigned to a user segment associated with the retrieved Internet activity information. Then, an advertisement is served based on the assigned advertising strategy.

### FIELD OF THE INVENTION

This invention relates to commercial internet communication, and more particularly to evaluation of commercial and advertising communication.

### BACKGROUND AND SUMMARY OF THE INVENTION

The Internet is an effective tool for commercial communication. Companies use electronic communications to consumers to cost-effectively promote their goods or services. Normally, an Advertising Service Company (ASC) contracts with web publishers with advertising space, and with advertisers. Advertisements for the advertisers are placed on the publisher's sites, to be viewed by users while visiting those sites. Each time a use visits, a unique identifier (e.g. cookie) associated with the computer or other device employed by the user is collected by the advertising service company, and information about the visit stored in the company's database. The collected information does not identify the user, yet is useful to correlate past activity associated with the uniquely identified and anonymous cookie

As in all forms of advertising and marketing, Internet advertisers seek to use strategies that are as cost effective as possible. This typically involves conceiving new strategies or advertising message content, testing them in comparison to proven strategies, and adopting those strategies that prove superior. Whether an advertisement is considered superior is determined generally by whether it results in the activity sought, typically a site visit that includes a purchase. Existing methods attribute such activity to ads are based on an algorithm that assigns credit to the last advertisement served to the purchaser. Based on the numbers of times each ad was served, a rate of success, or “conversion rate,” is determined. However, users often see many different ads before a conversion and these prior ads can often be the true driving force behind the conversion. Yet, credit is given only to the last ad viewed. Thus, ad effectiveness in the industry today is often improperly evaluated, leading to sub-par optimization and learning.

In addition, different sequences of ads may have different effects, yet the impact of the interactions between ads will not be identified. These and other effects serve to limit the effectiveness of studies, masking some important effects, weakening the determination about each ad, and increasing the resources required to gain a given amount of meaningful data.

The present invention overcomes the limitations of the prior art by enabling clean testing. The testing capability of the invention allows the flexible creation of “test” groups which consist of randomized groups of anonymous cookies. Each cookie, once randomized, never leaves that assigned test group. Each test group can then be exposed to a single advertising strategies, allowing unambiguous assignment of credit for conversions or other activity.

Another weakness of the prior art is that messaging is broadcast across the internet without regard to the specific needs of the users. Thus, the same message is given to all users, inevitably leading to wasted messaging to high proportions of users. The targeting capability of the invention overcomes this limitation by using Internet activity information associated with cookies to create user segments that are meaningful to advertisers. Each user segment is assigned an advertising strategy. When a user visits a site where an advertisement is to be served, a cookie is determined. The stored Internet activity information for the cookie is retrieved, and based on the retrieved information, the cookie is assigned to a user segment associated with the retrieved Internet activity information. Then, an advertisement is served based on the assigned advertising strategy.

### BRIEF DESCRIPTION OF THE DRAWINGS

FIG. 1 is a schematic block diagram showing the system and method of operation according to a preferred embodiment of the invention.

FIG. 2 is a schematic block diagram showing a sample test protocol according to a preferred embodiment of the invention.

### DETAILED DESCRIPTION OF A PREFERRED EMBODIMENT

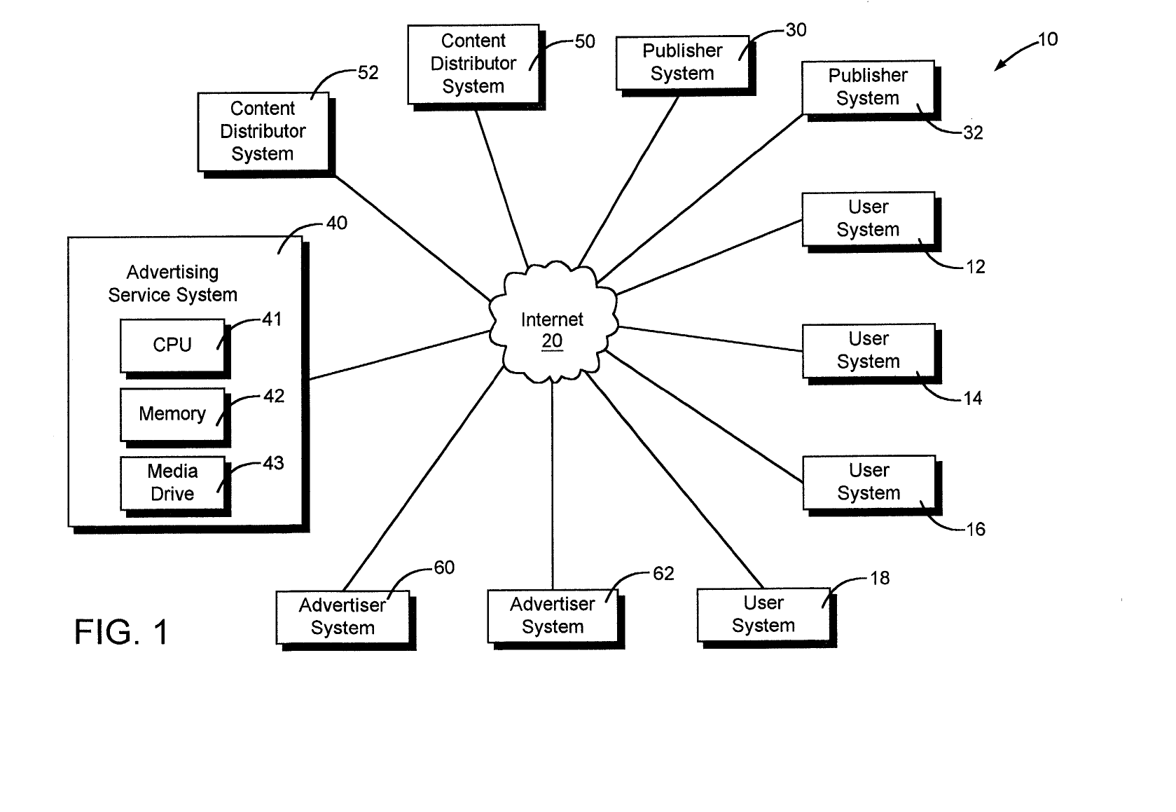

FIG. 1 is a high-level block diagram showing the environment and facility 10 in which the method preferably operates. The diagram shows a number of Internet customer or user computer systems 12, 14, 16, 18. An Internet customer preferably uses one such Internet customer computer system to connect, via the Internet 20, to an Internet publisher computer system, such as Internet publisher computer systems 30 and 32, to retrieve and display a Web page. Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the Internet advertising service company, has purchased advertising space on the Web page provided to the Internet customer computer system by the Internet publisher computer system, the Web page contains a reference to a URL in the domain of the Internet Advertising Service Company (ASC) computer system 40. When a customer computer system receives a Web page that contains such a reference, the Internet customer computer systems sends a request to the Internet advertising service computer system to return data comprising an advertising message, such as a banner advertising message. When the Internet advertising service computer system receives such a request, it selects an advertising message to transmit to the Internet customer computer system in response the request. Then, it either transmits the selected advertising message itself, or redirects the request containing an identification of the selected advertising message to an Internet content distributor computer system, such as Internet content distributor computer systems 50 and 52. When the Internet customer computer system receives the selected advertising message, the Internet customer computer system displays it within the Web page. The Internet advertising service is not limited to banner advertisements, which are used as an example. Other Internet advertising modes include email messages directed to a user who has provided his or her email address in a request for such messages.

The displayed advertising message preferably includes one or more links to Web pages of the Internet advertiser's Web site. When the Internet customer selects one of these links in the advertising message, the Internet customer computer system de-references the link to retrieve the Web page from the appropriate Internet advertiser computer system, such as Internet advertiser computer system 60 or 62. In visiting the Internet advertiser's Web site, the Internet customer may traverse several pages, and may take such actions as purchasing an item or bidding in an auction. The Internet advertising service computer system 40 preferably includes one or more central processing units (CPUs) 41 for executing computer programs such as the facility, a computer memory 42 for storing programs and data, and a computer-readable media drive 43, such as a CDROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

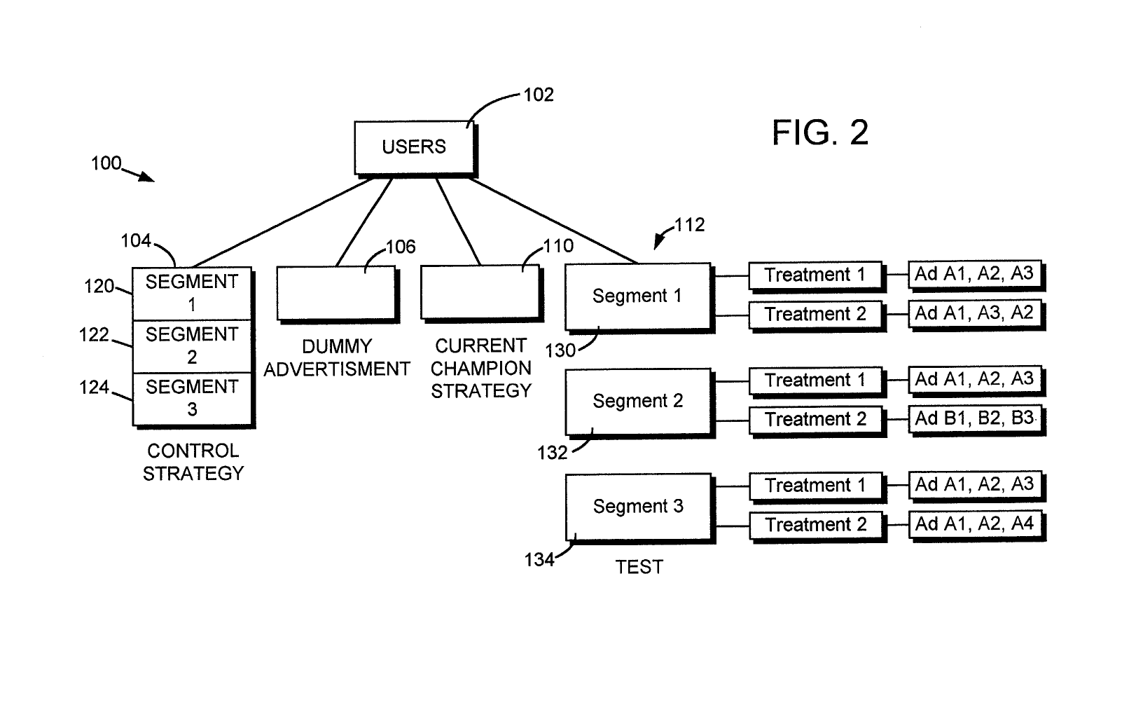

FIG. 2 shows a schematic representation 100 of a testing strategy under a preferred embodiment of the invention. The method is conducted by the Advertising Service Company, on receiving a device cookie from each user. The collection of users 102 is divided into different groups 104, 106, 110, 112 over the course of a test designed to determine the effectiveness of proposed advertising strategies. The users are identified only as the cookies associated with their devices, so in fact a single user may be represented more than once if he uses multiple devices, or a single device cookie may represent more than one user, if the device is so shared. The cookie is one that has been assigned to the user's machine previously, on the user's first encounter with an advertisement served by the Advertising Service Company (ASC), and is retrieved by the ASC before the advertisement is served.

Each user or cookie is pre-assigned to one of the groups, without regard to any information that may or may not be known about the user. This random assignment process is conducted to achieve a preselected percentage of the user population in each of the groups. Because all the user visits do not happen simultaneously, the assignment is made by a randomizing function that assigns each single user at the time of the visit, to achieve the end result of the desired percentages in each group. Which group and segment a user is in determines the type of advertisement he is served upon a visit to a publisher site where the advertising service company is serving advertisements for the advertiser.

There are four groups in the illustrated embodiment, although the principles may apply to as few as two groups, or an unlimited number of groups beyond the four illustrated. Each group, and its subgroups or segments are given a selected advertising treatment, and the effectiveness of that treatment is evaluated by correlating it with subsequent behavior by the user. Typically, the behavior sought will be a “conversion”, such as a purchase by the user of the goods advertised.

A control group 104 receives a random rotation of advertisements. On a single visit, such a user receives a single advertisement randomly selected from a group established as part of an advertising campaign for the advertiser, and to be displayed as banner ads, for instance, on the publisher's site. The advertisement is selected from a group of advertisements, and served to the user. Should the user make a subsequent visit to a site on which the advertising service company is serving ads (which may be a different publisher) the user's cookie is identified, and the user assigned another advertisement from the campaign at random. This simulates a basic advertising strategy in which no data about users is recalled, and therefore each visitor is served an ad without regard to ads previously viewed.

In the example, only six percent of users are assigned to the control group 104, as a limited sample size is adequate for comparison with the other groups. The control group includes three different segments 120, 122, 124, which indicate different user history or characteristics stored in the ASC database. In the control group, these segments all receive the same treatment. However, the effects of this common random treatment may be analyzed separately, each segment compared to a comparable segment in the test group 112, as will be discussed below.

Group 106 is assigned a “dummy” advertisement, so that all users to be served advertisements receive essentially no advertisement related to the campaign. Instead of a blank advertisement, a public service message such as a message soliciting support for an uncontroversial charitable organization such as the Red Cross. This provides another form of control, in that the conversion or purchase rate of this group establishes a baseline representing a scenario as if the advertiser did not advertise at all on the Internet. This control helps to account for purchases made as a result of word of mouth referrals, advertisements in other media, and the like. In the example, an adequate sample size is provided by assigning four percent of users to the dummy group.

Group 110 is the current “champion” strategy group. In this, the existing advertising technique is employed. This may be a simple technique in which a random collection of ads are served (in which case group 104 would be unnecessary.) More typically, it may include optimizing strategies that serve advertisements based on past user activity, or a multitude of other factors. There is no limitation on the level of sophistication. As innovations are developed and supplant each other as the current “state-of-the-art,” the “champion” group treatment will be updated, so that proposed alternatives to be tested may be compared to determine if they improve on the best known approach. Both the champion and dummy groups may be subdivided into segments as the control group, for later comparison with comparable segments in the test group. In the example, the champion group percentage is not determined by sample size needs. It is the current treatment from which the test and control groups are pared away, so normally includes most of the users. In this example, and sample size requirements of the other groups leave 72% in the champion group 110.

The test group 112 reflects the users who are assigned to a proposed advertising strategy to be tested. First, the users are segregated into segments 130, 132, 134. These segments are not random, but are based on past Internet activity as stored in the ASC database. The segments are hierarchical, so that a user that meets the criteria for more than one of the segments is assigned to the highest segment in the hierarchy of those he fits. For instance, segment 1 (130) may be the highest, and include visitors with the most extensive history, with the most prior site visits, or with a threshold level of past purchasing activity. The next segment 2 (132) may include those visitors with fewer visits, or visits within a certain range, but no purchase history. The next segment 3 (134) may be a default to capture those in the test group 112 who do not meet the criteria for the other segments. There may be innumerable other segments, depending on the needs of the test. Other possible criteria for segments include the web site currently being visited, the current page visited, the current type of activity (e.g. email, chat, shopping, news reading, searching, downloading, financial research) the current page visited), the current time of day, the current day of the week, a user interest category (e.g. sports, finance.) Criteria may include stored historical data, or real time data not requiring database access, or a combination.

A segment is defined by a segment formula, which is made up of a flexible number of cookie variables based on stored historical data, and real time variables as noted above, connected using logical operators. Variable values preferably resolve to integers, but this is not a requirement for alternative embodiments. The real time variables preferably include the current site being visited by the user, the current advertiser, and the current day, hour and date. For example, a segment formula may be:

(iImpCount>10)AND(iActCount>4)AND(CurrentSite( )=“publisher123”),

where iImpCount is the number of historic impressions (or a time-weighted function thereof), and iActCount is based on historical action data such as purchases. When all criteria of the cookie are satisfied, the cookie (user) is assigned to that segment unless it also qualifies for another higher segment.

Within each segment, the users may receive any number of alternative treatments, a treatment being a selected advertisement, sequence of advertisements, or particular advertising strategy or protocol. In the illustrated embodiment, each segment receives one of at least two different treatments. As the segmentation discussed above provides for analysis of different types of users, the use of different treatments in each segment provides for testing of different messages.

In the first segment 130, the segment member users are randomly assigned to a first or second treatment. These treatments each include a sequence of advertisements. In this segment, the advertisements are the same (A1, A2, A3), but the sequences differ. This allows the optional evaluation of the synergistic effect of advertisements in the different sequences. Variations on this may include a greater number of sequences to include all possible permutations of the advertisements, permitting a regression analysis of the results to detect any patterns regarding the sequential placement of a given ad, or the relations between ads. In the second segment, the treatments include entirely different populations of advertisements, for comparing two independent sequences of advertisements. In segment three, the treatments include some common ads, and at least one ad differing between treatments. One may simply test one ad versus a second ad. Or,with the addition of other channels like email, one may assign one part of the segment to receive an email and banner advertisements, while the other receives only banners, for instance. One may also determine if integration of messaging between emails and banners improves performance relative to non-integrated communication.

Because it takes time for a user to make multiple visits for all the ads of a treatment to be served, each interaction is stored in the database, so that upon a subsequent visit, the next proper ad in the sequence is served. There may also be an interval before a conversion occurs, or before it can reasonably can be assumed that no action has been stimulated by the treatment. In the case of ads served that may be “clicked” to generate action, the feedback may be prompt. In other cases, action may follow delivery of the final ad in the sequence. This raises another possible variable in evaluating the treatment effectiveness: mean time to conversion. In addition, conversions occurring after greater delay may be assumed less likely to have been stimulated by the treatment, and therefore de-weighted in the analysis. This may be used in an alternative embodiment variant in which the limitations of the prior art are tolerable.

In the preferred embodiment, at the process examines the number of conversions per test group, making reference to and analysis of time lag unnecessary. If one group that sees ad 1 purchases 1000 times over 3 months while the control group that saw ad 2 purchases 100 times over 3 months, one may conclude that ad 1 caused ten times more purchases over that long time frame. This is an important advantage of creating test/control groups. While existing methods only give credit for actions within 2 weeks of viewing an ad, this preferred embodiment eliminates any arbitrary limit.

The analysis may include not just comparison within each segment to determine which of the tested treatments is most effective for that segment, but also between segments to determine which segments may be above and below the threshold justifying advertising investment. Moreover, any promising treatment is compared with the different control groups to ensure that the treatment is significantly better than no advertisement, the current strategy, or another control strategy. In particular, the corresponding segment in any of these control groups that have been similarly segmented is compared.

The lessons learned about advertising treatment effectiveness may be implemented in real time. Using automated statistical models, when a treatment has achieved superior performance that is determined to have statistical significance given the limited but growing number of treatments served, that treatment may be implemented as the champion. Alternatively, the treatment may be implemented for those in the segment in which it proved successful. If it is desired that the experiment proceed, the percentage allocation of the groups and segments may be adjusted to favor more successful treatments, and to weed out less successful treatments.

While the above is discussed in terms of preferred and alternative embodiments, the invention is not intended to be so limited.

1. A method of serving Internet advertisements to users having associated cookies comprising:
establishing at least two advertising strategies;
for each cookie, assigning an advertising strategy;
serving advertisements to the cookie based on the assigned strategy; and
wherein at least a first one of the advertising strategies includes a first sequence of different advertisements.

2. The method of claim 1 wherein at least one advertising strategy comprises a control strategy including random assignment of advertisements.

3. The method of claim 1 wherein at least one advertising strategy comprises a control strategy including messages having control content unrelated to the other advertisements.

4. The method of claim 1 including comparing the effects of the advertising strategies.

5. The method of claim 4 including adopting an advertising strategy based on the comparison.

6. The method of claim 1 including for each cookie assigned to one of the advertising strategies, determining at least one Internet information characteristic, and assigning the cookie to a segment based on the characteristic.

7. The method of claim 5 wherein the Internet information characteristic is selected from a group of characteristics comprising past browsing activity, past advertisements served, current time, current day, interest category, current site, current page, and current activity type.

8. The method of claim 1 wherein assigning an advertising strategy is done randomly.

9. The method of claim 1 wherein at least a second one of the advertising strategies includes a second sequence of different advertisements.

10. The method of claim 9 wherein the first sequence and the second sequence include at least one common advertisement.

11. A method of evaluating Internet advertisement effectiveness comprising:
collecting Internet activity information associated with a multitude of cookies;
storing the information in a database;
generating an advertisement strategy for evaluation;
establishing a plurality of user segments, each having a different Internet activity characteristic;
assigning an advertising strategy to each segment;
determining a cookie for a user to whom an advertisement is to be served;
retrieving the stored Internet activity information for the cookie;
based on the retrieved information assigning the cookie to a user segment associated with the retrieved Internet activity information; and
serving an advertisement based on the assigned advertising strategy.

12. The method of claim 11 including generating a different advertising strategy for at least some of the different segments.

13. The method of claim 11 wherein assigning an advertising strategy includes selecting a sequence of different advertisements.

14. The method of claim 13 wherein each of at least a plurality of strategies includes a different sequence of advertisements.

15. The method of claim 14 wherein 13 wherein each of at least a plurality of strategies includes a common advertisement.

16. The method of claim 11 wherein at least one advertising strategy comprises a control strategy including random assignment of advertisements.

17. The method of claim 11 wherein at least one advertising strategy comprises a control strategy including messages having control content unrelated to the other advertisements.

18. The method of claim 17 including adopting an advertising strategy based on the comparison.

19. The method of claim 11 including for each cookie, determining at least one Internet information characteristic, and assigning the cookie to a segment based on the characteristic.

20. The method of claim 19 wherein the Internet activity characteristic is selected from a group of characteristics comprising past browsing activity, past advertisements served, current time, current day, interest category, current site, current page, and current activity type.
